(19) United States
(12) Patent Application Publication
(10) Pub. No.: US 2012/0268559 A1
(43) Pub. Date: Oct. 25, 2012

(54) ELECTRONIC APPARATUS AND DISPLAY CONTROL METHOD

(76) Inventor: Atsushi Watanabe, Ome-shi (JP)

(21) Appl. No.: 13/356,315

(22) Filed: Jan. 23, 2012

(30) Foreign Application Priority Data
Apr. 19, 2011 (JP) 2011-093417

(51) Int. Cl. H04N 13/04

(52) U.S. Cl. 348/43; 348/E13.026

(57) ABSTRACT

According to one embodiment, an electronic apparatus includes a display control module and a display mode changing module. The display control module displays in 2D display mode each of frame images of video content data which is a target of display, and displays, in first 3D display mode, a 3D image by using, as a left-eye image and a right-eye image, images on two areas in each of the frame images of the video content data which is the target of display. The display mode changing module changes a display mode of the display control module from the first 3D display mode to the 2D display mode if a switch request for switching the video content data, which is the target of display, to other video content data occurs while the display control module is displaying the video content data in the first 3D display mode.

### CROSS-REFERENCE TO RELATED APPLICATIONS

This application is based upon and claims the benefit of priority from prior Japanese Patent Application No. 2011-093417, filed Apr. 19, 2011, the entire contents of which are incorporated herein by reference.

### FIELD

Embodiments described herein relate generally to an electronic apparatus which plays back three-dimensional video content, and a display control method which is applied to this apparatus.

### BACKGROUND

In recent years, there have been developed various electronic apparatuses, such as a personal computer or a TV, which have a function for displaying three-dimensional image (3D image). As 3D image display techniques, there are known a 2D to 3D display technique of displaying 3D image by using 2D to 3D conversion which converts two-dimensional (2D) image to 3D image, and a 3D video display technique which displays 3D image corresponding to 3D video data (3D content).

At present, most of broadcast contents, such as TV broadcast programs, are 2D contents. A 2D to 3D display mode, which is a 3D display mode using the 2D to 3D display technique, is used in order to display 3D images corresponding to such 2D contents.

3D contents, such as 3D broadcast programs, have a 3D video format such as a side-by-side format or a top-and-bottom format. A 3D video display mode, which is a 3D display mode using the 3D video display technique, can display 3D image corresponding to the 3D content of the 3D video format.

In addition, recently, there has been developed a technique of automatically adjusting the level of depth which is estimated by 2D to 3D conversion.

As has been described above, it is presupposed that the 3D video display mode using the 3D video display technique is applied to the 3D video data of the 3D video format. If content that is a target of display is switched to ordinary 2D video content while the 3D video display mode is being used, it is possible that a picture of each frame in the 2D video content cannot correctly be displayed.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary perspective view illustrating a external appearance of an electronic apparatus according to an embodiment.

FIG. 2 is an exemplary block diagram illustrating a system configuration of the electronic apparatus of the embodiment.

FIG. 3 is an exemplary view illustrating a display screen which is displayed by the electronic apparatus of the embodiment.

FIG. 4 is an exemplary view illustrating a 3D imaging function setup screen which is displayed by the electronic apparatus of the embodiment.

FIG. 5 is an exemplary view illustrating a display image corresponding to 2D video data, which is displayed while the electronic apparatus of the embodiment is in a 2D to 3D display mode.

FIG. 6 is an exemplary view illustrating a display image corresponding to 3D video data, which is displayed while the electronic apparatus of the embodiment is in a 3D video display mode.

FIG. 7 is an exemplary view illustrating a display image corresponding to 2D video data, which is displayed while the electronic apparatus of the embodiment is in a 2D display mode.

FIG. 8 is an exemplary view illustrating a display image corresponding to 3D video data, which is displayed while the electronic apparatus of the embodiment is in the 2D display mode.

FIG. 9 is an exemplary view illustrating a display image corresponding to 2D video data, which is displayed while the electronic apparatus of the embodiment is in the 3D video display mode.

FIG. 10 is an exemplary view illustrating a display image corresponding to 3D video data, which is displayed while the electronic apparatus of the embodiment is in the 2D to 3D video display mode.

FIG. 11 is an exemplary block diagram illustrating a configuration of a video content playback program which is executed by the electronic apparatus of the embodiment.

FIG. 12 is an exemplary flow chart illustrating a procedure of a display mode switching process for switching between a 2D display mode and a 3D display mode (2D to 3D display mode or 3D video display mode), this process being executed by the video content playback program of FIG. 11.

FIG. 13 is an exemplary flow chart illustrating a procedure of a display mode auto-switching process which is executed by the video content playback program of FIG. 11 at a time of channel switching.

FIG. 14 is an exemplary flow chart illustrating another procedure of the display mode auto-switching process which is executed by the video content playback program of FIG. 11 at a time of channel switching.

### DETAILED DESCRIPTION

Various embodiments will be described hereinafter with reference to the accompanying drawings.

In general, according to one embodiment, an electronic apparatus includes a display control module and a display mode changing module. The display control module is configured to display in a two-dimensional display mode each of frame images of video content data which is a target of display, and to display, in a first three-dimensional display mode, a three-dimensional image by using, as a left-eye image and a right-eye image, images on two areas in each of the frame images of the video content data which is the target of display. The display mode changing module is configured to change a display mode of the display control module from the first three-dimensional display mode to the two-dimensional display mode if a switch request for switching the video content data, which is the target of display, to other video content data occurs while the display control module is displaying the video content data, which is the target of display, in the first three-dimensional display mode.

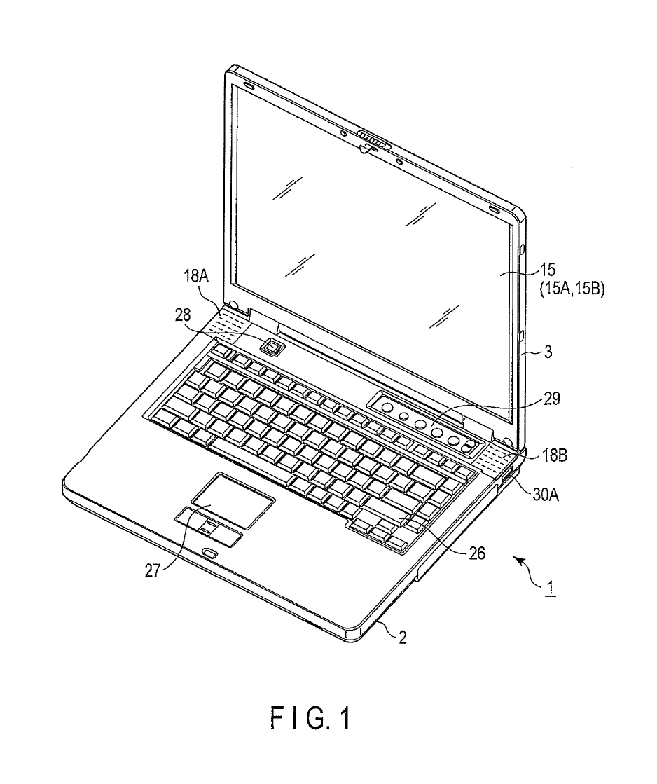

FIG. 1 is a perspective view showing the external appearance of an electronic apparatus according to an embodiment. The electronic apparatus is realized, for example, as a notebook-type personal computer (PC) 1. In addition, the electronic apparatus may be realized as a TV receiver (TV), a recorder (e.g. hard disk recorder, DVD recorder) for storing video data, a tablet PC, a slate PC, a PDA, a car navigation apparatus, a smart-phone, etc.

As shown in FIG. 1, the computer 1 comprises a computer main body 2 and a display unit 3.

A three-dimensional display (3D display) 15 is built in the display unit 3. The display unit 3 is attached to the computer main body 2 such that the display unit 3 is rotatable between an open position where the top surface of the computer main body 2 is exposed, and a closed position where the top surface of the computer main body 2 is covered. The 3D display 15 comprises an LCD (liquid crystal display) 15A and a lens unit 15B. The lens unit 15B is attached on the LCD 15A. The lens unit 15B includes a plurality of lens mechanisms for emitting, in predetermined directions, a plurality of light rays corresponding to a plurality of pixels included in an image that is displayed on the LCD 15A. The lens unit 158 is a liquid crystal GRIN (gradient index) lens which can electrically switch functions necessary for displaying 3D image. In the liquid crystal GRIN lens, for example, a designated area in the screen can be set to be a 3D image display area, and the other area can be set to be a 2D image display area. In the 3D image display area, the refractive indices of the lens mechanisms corresponding to the 3D image display area are varied so that 3D image including left-eye image and right-eye image, which is displayed in the 3D image display area, may have a parallax corresponding to an eye separation distance or a viewing distance. The operations of the lens mechanisms corresponding to the 2D image display area are turned off, and 2D image, which is to be displayed in the 2D image display area, is displayed as such, without being refracted.

The 3D display 15 displays 3D image, in which a left-eye image and a right-eye image are composited, on the 3D image display area, and displays 2D image on the 2D image display area. Thus, the user can perceive 3D image when viewing the 3D image display area in the screen, and can perceive 2D image when viewing the 2D image display area in the screen.

In the meantime, a 2D display, such as an ordinary LCD, may be used in place of the 3D display. In this case, for the display of 3D image, use may be made of, for example, a shutter method (also referred to as “time-division method”). In the 3D imaging by the shutter method, a stereo-pair video data including left-eye video data and right-eye video data is used. The display 15 is driven at a refresh rate (e.g. 120 Hz) which is double higher than the normal refresh rate (e.g. 60 Hz). The left-eye frame data in the left-eye video data and the right-eye frame data in the right-eye video data are alternately displayed on the LCD 15 with a refresh rate of, e.g. 120 Hz. For example, by using 3D glasses (not shown) such as liquid crystal shutter glasses, the user can view the image corresponding to the left-eye frame by the left eye and the image corresponding to the right-eye frame by the right eye. The 3D glasses may be configured to receive a sync signal, which indicates a display timing of each of the left-eye frame data and right-eye frame data, from the computer 1 by using, e.g. infrared. The left-eye shutter and right-eye shutter in the 3D glasses are opened/closed in synchronization with each of the display timing of the left-eye frame data and right-eye frame data on the LCD 15.

Alternatively, for the display of 3D video, use may be made of a polarization method such as an Xpol (trademark) method. In this case, for example, interleaved frames, in which a left-eye image and a right-eye image are interleaved in units of a scanning line, are generated, and the interleaved frames are displayed on the LCD 15. A polarizing filter covering the screen of the LCD 15 polarizes in different directions the left-eye image, which is displayed, for example, in odd-numbered lines on the screen of the LCD 15, and the right-eye image, which is displayed in even-numbered lines on the screen of the LCD 15. By using polarization glasses, the user can view the left-eye image by the left eye and the right-eye image by the right eye.

The computer main body 2 has a thin box-shaped housing. A keyboard 26, a power button 28 for powering on/off the personal computer 1, an input operation panel 29, a pointing device 27, and speakers 18A and 18B are disposed on the top surface of the housing of the computer main body 2. Various operation buttons are provided on the input operation panel 29. The buttons include operation buttons for controlling a TV function (viewing, recording and playback of recorded broadcast program data/video data).

An antenna terminal 30A for TV broadcast is provided, for example, on a right-side surface of the computer main body 2. In addition, an external display connection terminal supporting, e.g. the HDMI (high-definition multimedia interface) standard is provided, for example, on a rear surface of the computer main body 2. This external display connection terminal is used for outputting video data (moving picture data), which is included in video content data, such as broadcast program data, to an external display.

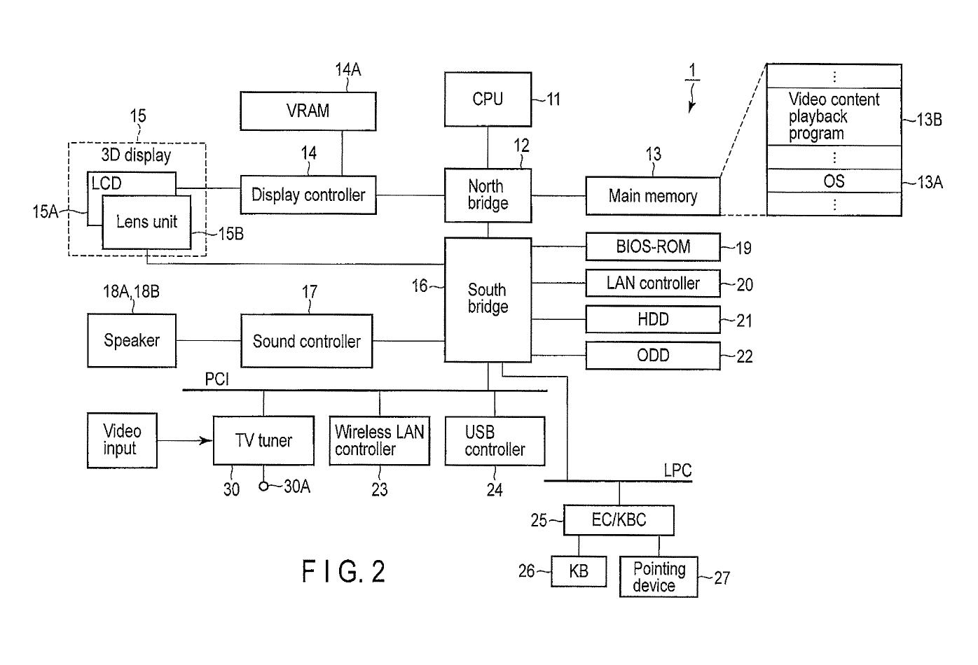

FIG. 2 shows the system configuration of the personal computer 1.

The computer 1, as shown in FIG. 2, comprises a CPU 11, a north bridge 12, a main memory 13, a display controller 14, a video memory (VRAM) 14A, 3D display 15, a south bridge 16, a sound controller 17, speakers 18A and 18B, a BIOS-ROM 19, a LAN controller 20, a hard disk drive (HDD) 21, an optical disc drive (ODD) 22, a wireless LAN controller 23, a USB controller 24, an embedded controller/keyboard controller (EC/KBC) 25, keyboard (KB) 26, pointing device 27, and a TV tuner 30.

The CPU 11 is a processor for controlling the operation of the computer 1. The CPU 11 executes an operating system (OS) 13A and application programs, which are loaded from the HDD 21 into the main memory 13. The application programs include a video content playback program 13B. The video content playback program 13B is software having a function for viewing video content data. The video content playback program 13B executes a live playback process for viewing broadcast program data which is received by the TV tuner 30, a recording process for recording the received broadcast program data in the HDD 21, a playback process for playing back video content data (e.g. broadcast program data, video title, etc.) which is recorded in the HDD 21, and a playback process for playing back video content data which is received via a network. Besides, the video content playback program 13B can play back video content data which is stored in storage media such as a DVD.

Furthermore, the video content playback program 13B has a function for displaying three-dimensional image (3D image). The video content playback program 13B includes a two-dimensional display mode (2D display mode) and two three-dimensional display modes (3D display modes).

The 2D display mode is a display mode for displaying 2D image corresponding to normal 2D video data on the display 15. In the 2D display mode, the video content playback program 13B displays each of frame images of video content data, which is a target of display, on the display 15. The 3D display modes include a 3D video display mode and a 2D to 3D display mode.

The 3D video display mode is a 3D display mode for displaying 3D image corresponding to 3D video data of a 3D format. As the 3D video data of the 3D format, use is made of, for example, a 3D video format such as a side-by-side format or a top-and-bottom format. In the 3D video display mode, the video content playback program 13B displays 3D image by using, as a left-eye image and a right-eye image, images on two areas in each of frame images of video content data that is a target of display. When the 3D display 15 is used, images of two areas in each frame image are composited, and the composite image is displayed on a 3D image display area of the 3D display 15. For example, when the video content data that is the target of display is of the side-by-side format, an image (left-eye image) on a left half area of each frame image and an image (right-eye image) on a right half area of each frame image are composited, and the composite image is displayed on the 3D image display area of the 3D display 15.

Meanwhile, when the shutter method is used, for example, an image (left-eye image) on a left half area of each frame image and an image (right-eye image) on a right half area of each frame image are alternately displayed.

The 2D to 3D display mode is a 3D display mode for displaying 3D image by converting 2D video data to 3D video data. In the 2D to 3D display mode, the video content playback program 13B displays on the display 15 3D images which is obtained by converting video content data that is a target of display to 3D video data. Specifically, the video content playback program 13B generates a left-eye image and a right-eye image from each frame image of 2D video data by estimating the depth of each of pixels of each frame image of the 2D video data. Then, the video content playback program 13B displays 3D image by using the left-eye image and right-eye image generated from each frame image. When the 3D display 15 is used, the left-eye image and right-eye image generated from each frame image are composited, and the composite image is displayed on the 3D image display area of the 3D display 15.

As has been described above, for the display of 3D image, use may be made of a 3D display by a naked-eye stereopsis method (e.g. an integral imaging method, a lenticular method, or a parallax barrier method), or use may be made of a glasses method (e.g. a shutter method, or a polarization method).

Besides, the CPU 11 executes a BIOS (Basic Input/Output System) that is stored in the BIOS-ROM 19. The BIOS is a program for hardware control.

The north bridge 12 is a bridge device which connects a local bus of the CPU 11 and the south bridge 16. The north bridge 12 includes a memory controller which access-controls the main memory 13. The north bridge 12 also has a function of communicating with the display controller 14.

The display controller 14 is a device which controls the LCD 15 that is used as the display of the computer 1. A display signal, which is generated by the display controller 14, is sent to the LCD 15A. The LCD 15A displays images, based on the display signal.

The south bridge 16 controls devices on a PCI (Peripheral Component Interconnect) bus and devices on an LPC (Low Pin Count) bus. The south bridge 16 includes an IDE (Integrated Drive Electronics) controller for controlling the HDD 21 and ODD 22, and a memory controller which access-controls the BIOS-ROM 19. The south bridge 16 also has a function of communicating with the sound controller 17 and LAN controller 20.

Furthermore, the south bridge 16 can output to the lens unit 15B a control signal for executing such control as to set each of plural areas in the lens unit 15B to be either a 3D image display area or a 2D image display area, in accordance with, e.g. a request by the video content playback program 13B. In accordance with the control signal which has been output by the south bridge 16, the lens unit 15B varies, for example, the refractive index of that part of the liquid crystal layer, which corresponds to each of the plural areas, thereby setting each area to be either the 3D image display area or the 2D image display area.

When the 3D display 15 is configured to display two parallax images, the 3D image display area displays composite image which is obtained by compositing a left-eye image and a right-eye image. In this case, in the 3D image display area, for example, an associated pixel in the left-eye image is disposed at one of two pixel positions which neighbor in the horizontal direction, and an associated pixel in the right-eye image is disposed at the other of the two pixel positions which neighbor in the horizontal direction. Specifically, in each of horizontal lines in the 3D image display area, the left-eye image and right-eye image are alternately disposed on a pixel-by-pixel basis. Thereby, 3D image corresponding to 3D video data is displayed so that a left-eye image and a right-eye image in the 3D video data may be composited.

In the meantime, when the shutter method is used, as described above, it should suffice if the left-eye image and right-eye image are alternately displayed on a frame-by-frame basis. Thereby, the user is enabled to perceive 3D image in which the left-eye image and right-eye image are composited.

The sound controller 17 is a sound source device and outputs audio data, which is a target of playback, to the speakers 18A and 18B. The LAN controller 20 is a wired communication device which executes wired communication of, e.g. the Ethernet (trademark) standard. The wireless LAN controller 23 is a wireless communication device which executes wireless communication of, e.g. the IEEE 802.11 standard. In addition, the USB controller 24 communicates with an external device via a cable of, e.g. the USB 2.0 standard.

The EC/KBC 25 is a one-chip microcomputer in which an embedded controller for power management and a keyboard controller for controlling the keyboard (KB) 26 and pointing device 27 are integrated. The EC/KBC 25 has a function of powering on/off the computer 1 in accordance with the user's operation.

The TV tuner 30 is a reception device which receives broadcast program data that is broadcast by a television (TV) broadcast signal, and the TV tuner 30 is connected to the antenna terminal 30A. Needless to say, the TV tuner 30 may be configured to receive a TV broadcast signal by using a built-in antenna. The TV tuner 30 is configured to receive a broadcast signal, to select a channel in the broad cast signal, which is a target of viewing, and to output broadcast program data of the selected channel which is the target of viewing. As the TV tuner 30, for example, a plurality of tuners may be provided for broadcast signals corresponding to ground digital broadcast, BS digital broadcast and CS digital broadcast, respectively. In addition, the TV tuner 30 has a function of capturing video data which is input from an external device.

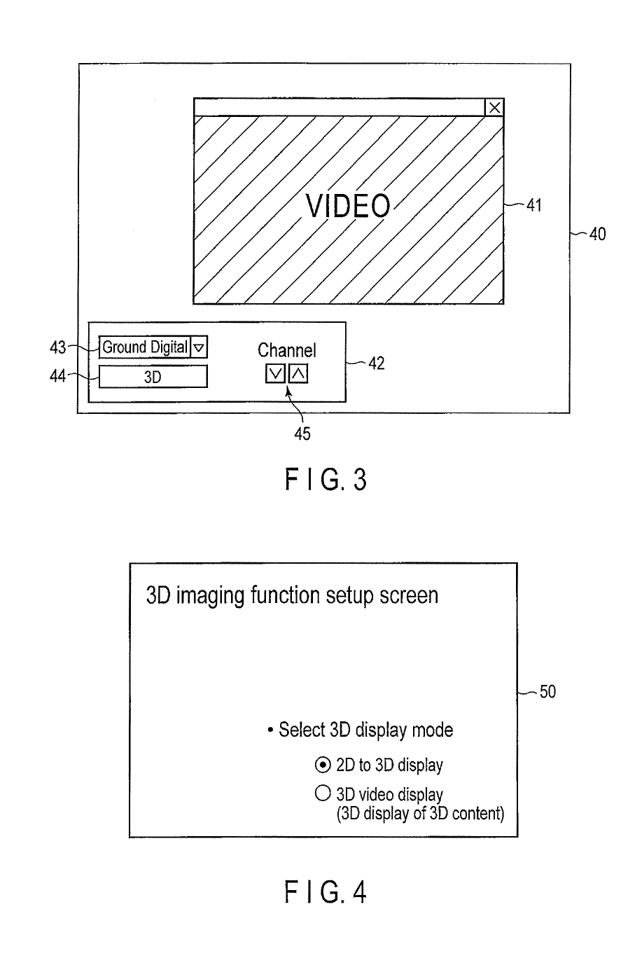

FIG. 3 shows an example of a display screen 40 which is displayed on the display 15 by the video content playback program 13B. The display screen 40 displays a video display window 41 for displaying video content data, and a control panel 42 which is a GUI for prompting the user to control the operation of the video content playback program 13B. Needless to say, the video display window 41 may be displayed on the display screen in a full-screen mode. When the display 15 is a 3D display, a rectangular area on the display screen, which corresponds to the video display window 41, is set to be a 3D image display area, and the other area is set to be a 2D image display area. The control panel 42 displays a pull-down menu 43 for selecting the kind of TV broadcast signal (ground digital broadcast, BS digital broadcast, or CS digital broadcast), a 3D button 44 for switching the display mode of the video content playback program 13B between a 2D display mode and a 3D display mode, and a channel switch button 45 for switching the channel that is to be selected by the TV tuner 30.

When the channel switch button 45 has been clicked by the user's operation of the pointing device while certain broadcast program data is being displayed, the channel that is the target of viewing, which is currently selected, is switched to another channel. Then, video corresponding to the broadcast program data of this another channel, which is output from the tuner 30, is displayed on the video display window 41.

In the meantime, the video content playback program 13B can display not only the broadcast program data, but also various kinds of other video content data such as a video clip, a home movie and a DVD video title. In this case, a menu showing a list of these video content data may be displayed on the display screen 40. When some other video content data on the menu has been selected by the user's operation of the pointing device while certain video content data is being displayed, the video content data that is the target of display is switched to the selected video content data. Then, video corresponding to the selected video content data is displayed on the video display window 41.

When the 3D button 44 has been clicked by the user's operation of the pointing device while the video content playback program 13B is displaying broadcast program data (video content data) in the 2D display mode, the display mode of the video content playback program 13B is switched from the 2D display mode to the 3D display mode (either the 2D to 3D display mode or 3D video display mode). Thereby, 3D image (3D video) corresponding to the broadcast program data (video content data) is displayed.

FIG. 4 shows an example of a 3D imaging function setup screen 50, which is displayed on the display 15 by the video content playback program 13B.

The 3D imaging function setup screen 50 is a setup screen for designating an operation of the video content playback program 13B at a time when the 3D button 44 has been pressed. The 3D imaging function setup screen 50 displays a radio button for prompting the user to designate either a “2D to 3D display” mode or a “3D video display” mode.

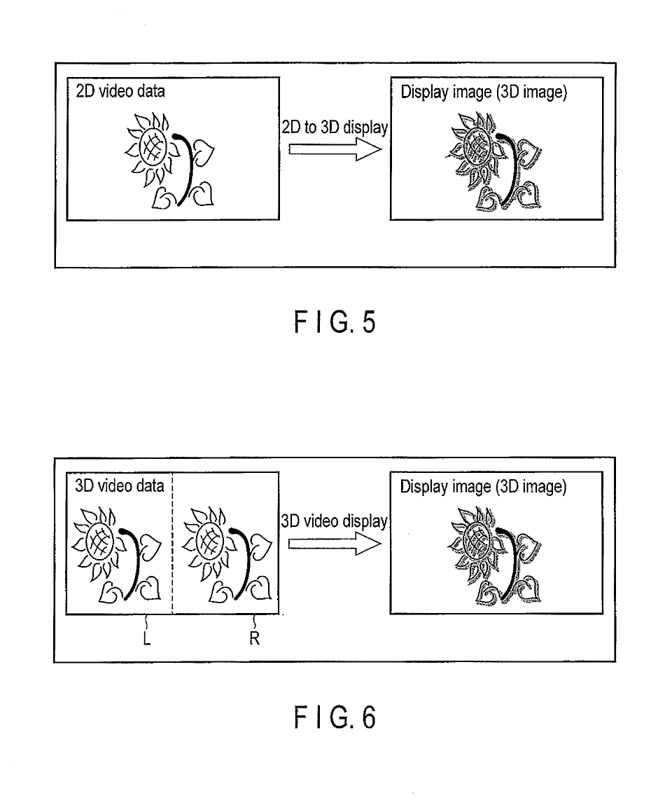

Next, referring to FIG. 5 to FIG. 10, a description is given of each of display modes of the video content playback program 13B.

FIG. 5 shows a display image corresponding to 2D video data, which is displayed while the video content playback program 13B is in the 2D to 3D display mode. A left part of FIG. 5 shows 2D video data that is the target of display, and a right part of FIG. 5 shows a display image on the screen of the display 15.

In the 2D to 3D display mode, the video content playback program 13B estimates a depth value of each of the pixels of each frame of the video content data that is the target of display, and generates a plurality of parallax images, for example, two parallax images, namely a left-eye image and a right-eye image, based on the estimated depth values. The video content playback program 13B displays 3D image by using the generated left-eye image and right-eye image.

To be more specific, the video content playback program 13B executes, in cooperation with a display driver, etc., a 3D display process of displaying the left-eye image and right-eye image on the 3D image display area on the screen of the display 15, so that the left-eye image and right-eye image may be composited.

In the 3D display process, for example, 3D image data is generated by compositing the left-eye image and right-eye image. In the 3D image data, for example, the left-eye image and right-eye image are alternately arranged on a line-by-line basis in the vertical direction. The 3D image data (interleaved image data), in which the left-eye image and right-eye image are alternately arranged on a line-by-line basis in the vertical direction, is displayed in the 3D image display area on the screen of the display 15. Thereby, 3D video corresponding to the 3D video data that is the target of display is displayed in the 3D image display area of the display 15.

FIG. 6 shows a display image corresponding to 3D video data, which is displayed while the video content playback program 13B is in the 3D video display mode. A left part of FIG. 6 shows 3D video data of a 3D format. In this example, it is assumed that the 3D video data of the 3D format is 3D video data of a side-by-side format. Needless to say, other 3D formats, such as a top-and-bottom format, may be used. A right part of FIG. 6 shows a display image on the screen of the display 15.

In the 3D video display mode, the video content playback program 13B displays, in cooperation with a display driver, etc., 3D image by using, as a left-eye image and a right-eye image, two images on two areas of each frame image of video content data that is the target of display (for example, a left-side image and a right-side image in each frame image).

To be more specific, the video content playback program 13B executes, in cooperation with a display driver, etc., the above-described 3D display process of displaying the left-eye image and right-eye image on the 3D image display area on the screen of the display 15, so that the left-eye image and right-eye image of each frame image of video content data may be composited.

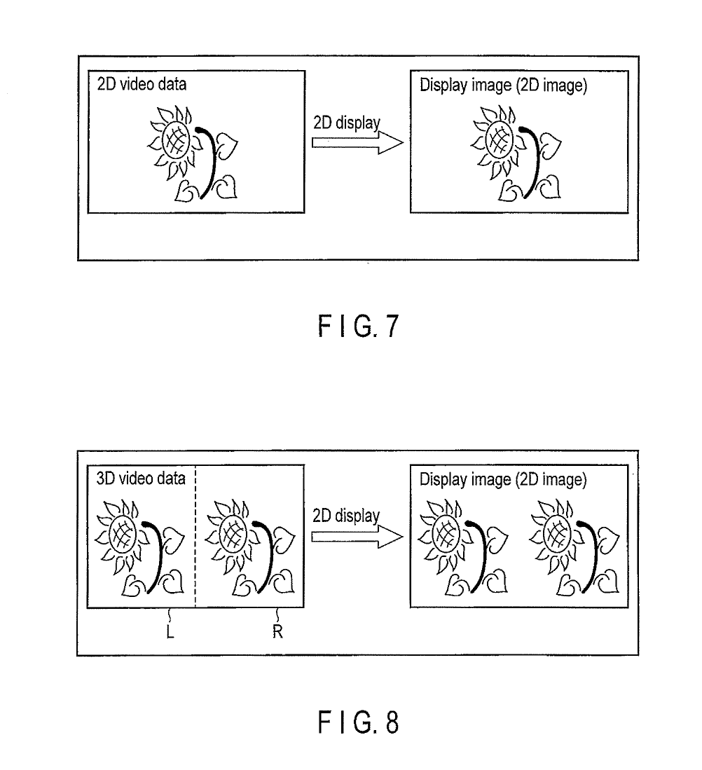

FIG. 7 shows a display image corresponding to 2D video data, which is displayed while the video content playback program 13B is in the 2D display mode. A left part of FIG. 7 shows ordinary 2D video data that is the target of display, and a right part of FIG. 7 shows a display image on the screen of the display 15.

In the 2D mode, the video content playback program 13B executes a 2D display process for successively displaying, on the display 15, frame images of video content data as such, which is the target of display (i.e. a process for displaying 2D image corresponding to 2D video data), without executing the above-described 3D display process (reconstruction) on the video content data that is the target of display.

FIG. 8 shows a display image corresponding to 3D video data, which is displayed while the video content playback program 13B is in the 2D display mode. A left part of FIG. 8 shows 3D video data of a 3D format, which is the target of display. In this example, it is assumed that the 3D video data of the 3D format is 3D video data of a side-by-side format. A right part of FIG. 8 shows a display image on the screen of the display 15.

As has been described above, in the 2D mode, the video content playback program 13B executes a 2D display process for successively displaying frame images of video content data that is the target of display. Thus, the left-eye image and right-eye image in each frame image of the side-by-side format are displayed as such on the screen of the display 15.

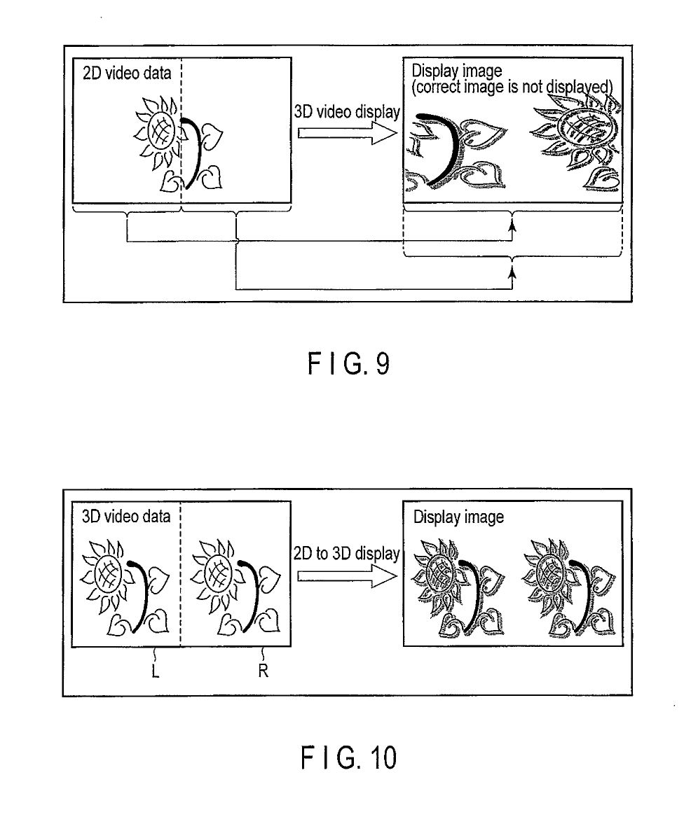

FIG. 9 shows a display image corresponding to 2D video data, which is displayed while the video content playback program 13B is in the 3D video display mode. A left part of FIG. 9 shows ordinary 2D video data which is the target of display, and a right part of FIG. 9 shows a display image on the screen of the display 15.

As has been described above, in the 3D video display mode, the video content playback program 13B displays, in cooperation with a display driver, etc., 3D image by using a left-side image and a right-side image in each frame image as a left-eye image and a right-eye image. Thus, if video data that is the target of display is 2D video data, a left-side image in each frame image of the 2D video data is used as a left-eye image, and a right-side image in each frame image of the 2D video data is used as a right-eye image. As a result, as shown in the right part of FIG. 9, it is possible that the design (composition) of the picture of each frame in the 2D video data is disordered and the picture of each frame is not correctly displayed. This situation may possibly occur, for example, when a switch request for switching the video content data that is the target of display to other video content data has been issued while the video content playback program 13B is in the 3D video display mode. The reason for this is that most of video content data is 2D video content data.

To be more specific, the above-described situation may occur when the user has executed an operation for channel switching while the user is enjoying 3D video corresponding to 3D video content data by using the 3D video display mode. In this case, the video of the broadcast program data of a new channel, which has been selected by the channel switching, cannot correctly be displayed.

Incidentally, a similar problem may occur when the 3D video display mode corresponds to 3D video content data of the top-and-bottom format. The reason for this is that the video content playback program 13B handles an upper-side image in each frame image of 2D video data as a left-eye image, and handles a lower-side image in each frame image of 2D video data as a right-eye image.

In addition, the above-described phenomenon in which the composition of the picture of each frame in 2D video data is disordered may occur not only when the 3D display is used, but also when the shutter method, for instance, is used. The reason for this is that a left-side image and a right-side image of each frame in 2D video data are alternately displayed as a left-side image and a right-side image.

FIG. 10 shows a display image corresponding to 3D video data, which is displayed while the video content playback program 13B is in the 2D to 3D display mode. A left part of FIG. 10 shows 3D video data of a 3D format, which is the target of display. In this example, it is assumed that the 3D video data of the 3D format is 3D video data of a side-by-side format. A right part of FIG. 10 shows a display image on the screen of the display 15.

As has been described above, in the 2D to 3D display mode, the video content playback program 13B estimates a depth value of each of the pixels of each frame of the video content data that is the target of display, and generates two parallax images, namely a left-eye image and a right-eye image, based on the estimated depth values. The video content playback program 13B executes, in cooperation with a display driver, etc., a 3D display process for displaying 3D image on the 3D image display area on the screen of the display 15 by using the left-eye image and right-eye image. Thus, if the 3D video data of the side-by-side format is processed in the 2D to 3D display mode, 3D image corresponding to the entirety of each frame image of 3D video data is displayed on the screen of the display 15. In other words, each of the left-eye image and right-eye image in the 3D video data is displayed as 3D image. However, unlike the case of FIG. 9, the composition of the picture of each frame is not disordered.

This situation may possibly occur, for example, when a switch request for switching the video content data that is the target of display to other video content data has been issued while the video content playback program 13B is in the 2D to 3D display mode. However, since most of video content data is 2D video content data, the probability of occurrence of the situation of FIG. 10 is low.

The video content playback program 13B of the present embodiment has a display mode changing function in order to prevent occurrence of the phenomenon in which the picture of video content is not correctly displayed.

According to this display mode changing function, when a video content switch request, such as a channel switch request, has occurred while video data is being displayed in the 3D video display mode, the current display mode of the video content playback program 13B is automatically switched to the 2D display mode. Thereby, even if the video content data that is the target of display is switched from 3D video content data to ordinary 2D video content data by channel switching, it is possible to prevent occurrence of the situation in which the picture of the video content data that is the target of display is not correctly displayed.

In addition, when a video content switch request, such as a channel switch request, has occurred while video data is being displayed in the 2D to 3D video display mode, the video content playback program 13B keeps the current display mode to be the 2D to 3D display mode. Since most of broadcast program data is 2D video data, 3D image corresponding to the broadcast program data after the switching can correctly be displayed by maintaining the 2D to 3D display mode.

Even if the broadcast program data after the switching is 3D video data, each of the left-eye image and right-eye image in the 3D video data is merely displayed as 3D image, as described with reference to FIG. 10, the picture itself is not disordered. Therefore, when a video content switch request, such as a channel switch request, has occurred while video data is being displayed in the 2D to 3D video display mode, it is effective to maintain the current 2D to 3D display mode.

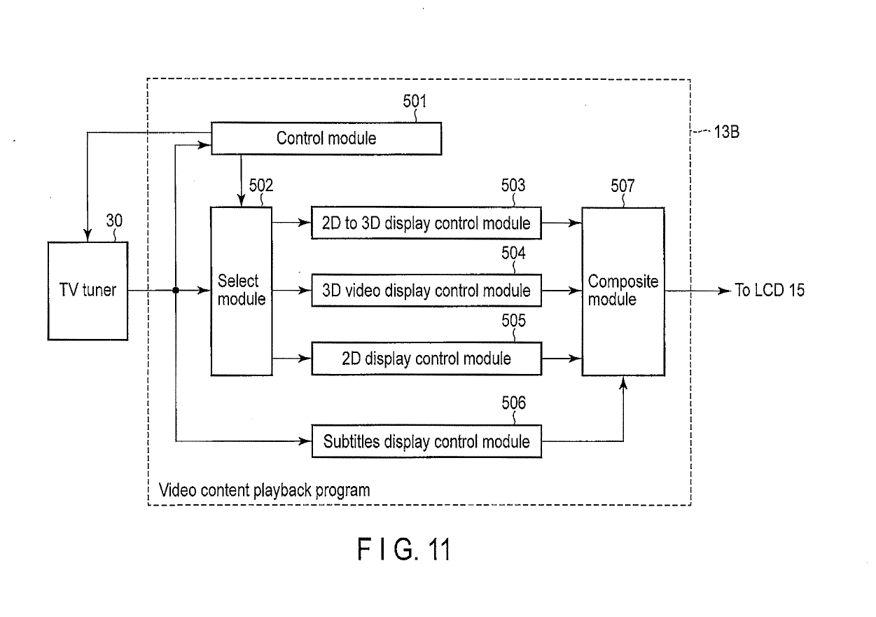

FIG. 11 is a block diagram illustrating an example of the functional structure of the video content playback program 13B.

The video content playback program 13B has a video playback function for playing back video content data, such as broadcast program data, as 3D image or 2D image. The video content playback program 13B comprises a control module 501, a select module 502, a 2D to 3D display control module 503, a 3D video display control module 504, a 2D display control module 505, a subtitles display control module 506, and a composite module 507.

The control module 501 transmits a channel switch command to the TV tuner 30 in response to an operation of, e.g. the channel switch button 45 by the user. In addition, the control module 501 transmits a broadcast wave switch command to the TV tuner 30 in response to an operation of the pull-down menu 43 by the user. Furthermore, the control module 501 controls the select module 502, thereby executing a process of switching the display mode between the 2D to 3D display mode, 3D video display mode and 2D display mode. The control module 501 can function as a display mode changing module for executing the above-described display mode changing function.

The select module 502 selects, under the control of the control module 501, one of the display control modules 503, 504, and 505. The select module 502 sends broadcast program data (video content data), which is output from the TV tuner 30, to the selected display control module (the 2D to 3D display control module 503, 3D video display control module 504 or 2D display control module 505).

The 2D to 3D display control module 503 is a display control module for displaying video content data in the above-described 2D to 3D display mode. The 3D video display control module 504 is a display control module for displaying video content data in the above-described 3D video display mode. The 2D display control module 505 is a display control module for displaying video content data in the above-described 2D video display mode.

The subtitles display control module 506 executes a process for displaying image corresponding to subtitles data which is included in broadcast program data (video content data). The composite module 507 generates output video data in which video data, which is output from one of the 2D to 3D display control module 503, 3D video display control module 504 and 2D display control module 505, and subtitles video data, which is output from the subtitles display control module 506, are composited.

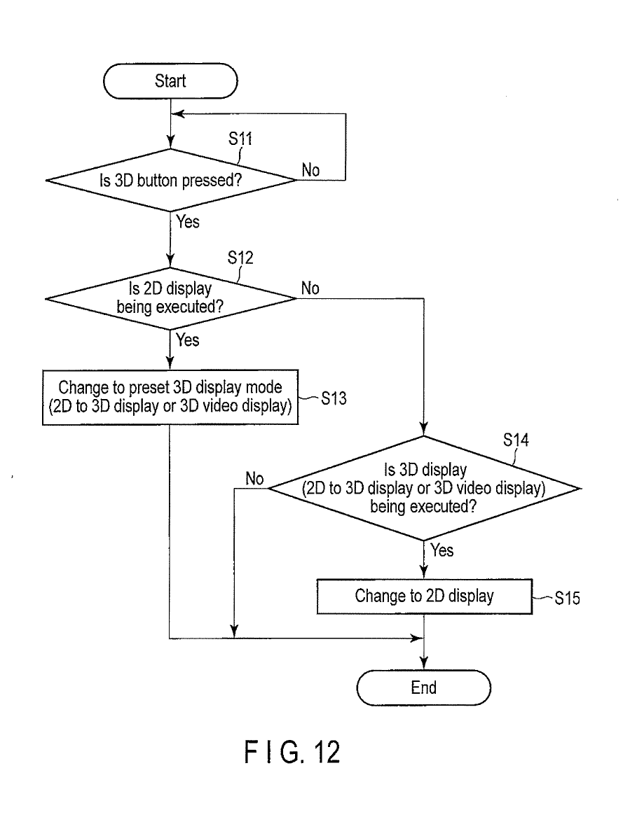

Next, referring to a flow chart of FIG. 12, a description is given of a display mode switching process which is executed by the video content playback program 13B. This display mode switching process is executed in response to an operation of pressing the above-described 3D button 44.

When the 3D button 44 has been pressed by the user (YES in step S11), the control module 501 of the video content playback program 13B determines whether the current display mode is the 2D display mode or 3D display mode (2D to 3D display mode or 3D video display mode) (step S12, S14).

If the current display mode is the 2D display mode (2D image is being displayed) (YES in step S12), the control module 501 changes the current display mode to a 3D display mode which is preset by the user (the 2D to 3D display mode or 3D video display mode) (step S13). In this case, the control module 501 controls the select module 502, thereby changing the display control module, which is to process the video data, from the 2D display control module 505 to either the 2D to 3D display control module 503 or 3D video display control module 504.

On the other hand, if the current display mode is the 3D display mode, that is, if 3D image is being displayed (YES in step S14), the control module 501 changes the current display mode to the 2D display mode (step S15). In this case, the control module 501 controls the select module 502, thereby changing the display control module, which is to process the video data, from either the 2D to 3D display control module 503 or 3D video display control module 504 to the 2D display control module 505.

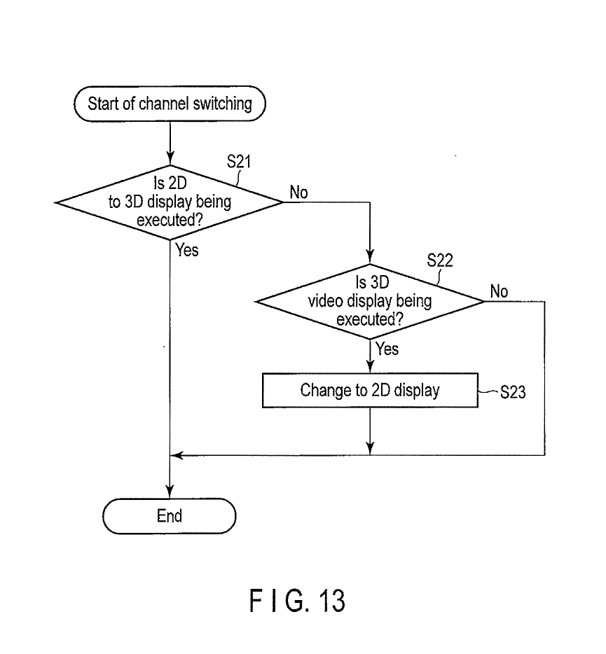

Next, referring to a flow chart of FIG. 13, a description is given of a display mode changing process which is executed by the video content playback program 13B at a time of channel switching.

When a channel switch request has occurred in response to an operation of, e.g. the channel switch button 45 by the user, the control module 501 of the video content playback program 13B transmits to the TV tuner 30 a channel switch command to designate a target channel of channel switching. In parallel with this channel switch process, or immediately after the channel switch process has been executed, the control module 501 executes the following process.

The control module 501 determines whether the current display mode is the 2D display mode or 3D display mode (2D to 3D display mode or 3D video display mode). If the current display mode is the 3D display mode, the control module 501 determines whether the 3D display mode is the 2D to 3D display mode or 3D video display mode. When the 3D display mode is the 3D video display mode, the control module 501 changes the current display mode to the 2D display mode.

Specifically, after transmitting the channel switch command to the TV tuner 30, the control module 501 first determines whether the current display mode is the 2D to 3D display mode or not (step S21). If the current display mode is the 2D to 3D display mode, that is, if video data is being displayed in the 2D to 3D display mode (YES in step S21), the control module 501 terminates the process.

If the current display mode is not the 2D to 3D display mode (NO in step S21), the control module 501 determines whether the current display mode is the 3D video display mode or not (step S22). If the current display mode is the 3D video display mode, that is, if video data is being displayed in the 3D video display mode (YES in step S22), the control module 501 changes the current display mode to the 2D display mode (step S23). In step S23, the control module 501 turns off the lens unit 15B, and controls the select module 502 to select the 2D display control module 505.

If the current display mode is not the 3D video display mode, that is, if video data is being displayed in the 2D display mode (NO in step S22), the control module 501 terminates the process.

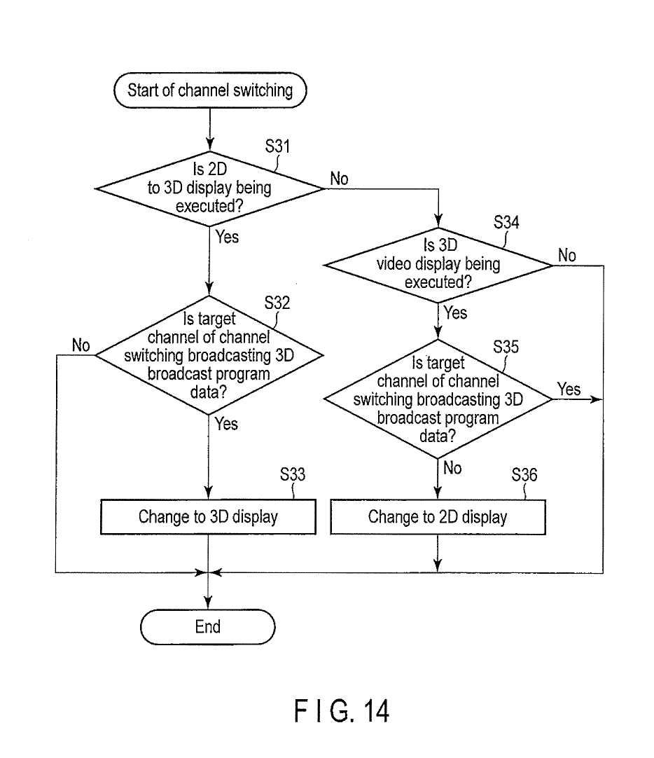

Next, referring to a flow chart of FIG. 14, a description is given of another example of the display mode changing process which is executed by the video content playback program 13B at a time of channel switching.

In this example, a process is added for determining, based on an identifier added to the broadcast program data of a target channel of channel switching, whether the broadcast program data of the target channel is 3D video data of a 3D format or not.

When a channel switch request has occurred in response to an operation of, e.g. the channel switch button 45 by the user, the control module 501 of the video content playback program 13B transmits to the TV tuner 30 a channel switch command to designate a target channel of channel switching. In parallel with this channel switch process, or immediately after the channel switch process has been executed, the control module 501 executes the following process.

The control module 501 first determines whether the current display mode is the 2D to 3D display mode or not (step S31). If the current display mode is the 2D to 3D display mode, that is, if video data is being displayed in the 2D to 3D display mode (YES in step S31), the control module 501 determines whether the broadcast program data of the target channel is 3D video data of a 3D format or not, by referring to an identifier which is added to the broadcast program data of the target channel (step S32).

If the broadcast program data of the target channel is the 3D video data of the 3D format, that is, if the target channel is broadcasting a 3D program (YES in step S32), the control module 501 changes the current display mode to the 3D video display mode (step S33). In step S33, the control module 501 controls the select module 502 to select the 3D video display control module 504. Thereby, the 3D display mode, which is suited to the kind of broadcast program data of the target channel, can be used.

If the broadcast program data of the target channel is not the 3D video data of the 3D format (NO in step S32), the control module 501 terminates the process.

If the current display mode is not the 2D to 3D display mode (NO in step S31), the control module 501 determines whether the current display mode is the 3D video display mode or not (step S34). If the current display mode is the 3D video display mode, that is, if video data is being displayed in the 3D video display mode (YES in step S34), the control module 501 determines whether the broadcast program data of the target channel is 3D video data of a 3D format or not, by referring to the identifier which is added to the broadcast program data of the target channel (step S35).

If the broadcast program data of the target channel is not the 3D video data of the 3D format, that is, if the target channel is not broadcasting a 3D program (NO in step S35), the control module 501 changes the current display mode to the 2D display mode (step S36). In step S36, the control module 501 turns off the lens unit 15B, and controls the select module 502 to select the 2D display control module 505.

If the current display mode is not the 3D video display mode, that is, if video data is being displayed in the 2D display mode (NO in step S34), the control module 501 terminates the process.

Besides, if the broadcast program data of the target channel is the 3D video data of the 3D format (YES in step S35), the control module 501 terminates the process in order to continue the display process using 3D video display mode.

The display mode changing processes, which have been described with reference to the flow charts of FIG. 13 and FIG. 14, may be executed not only when the channel switch operation has been performed by the user, but also when an operation of switching video data that is the target of display (e.g. a video clip, a home movie, or a DVD video title) has been performed by the user. Whether the video data that is the target of display is 3D video of a 3D format may be determined by referring to an identifier which is added to the video data that is the target of display.

As has been described above, according to the present embodiment, when a video content switch request, such as a channel switch request, has occurred while video content data is being displayed in the 3D video display mode, the display mode is automatically switched from the 3D video display mode to the 2D display mode. Therefore, it is possible to prevent occurrence of such a phenomenon that the picture of the video content is not correctly displayed.

Since the procedure of the display control process of the embodiment can be executed by software, the same advantageous effects as with the present embodiment can easily be obtained by simply installing a program, which executes the procedure of this display control process, into an ordinary computer through a computer-readable storage medium which stores the program, and executing the program.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic apparatus comprising:
a display control module configured to display in a two-dimensional display mode each of frame images of video content data which is a target of display, and to display, in a first three-dimensional display mode, a three-dimensional image by using, as a left-eye image and a right-eye image, images on two areas in each of the frame images of the video content data which is the target of display; and
a display mode changing module configured to change a display mode of the display control module from the first three-dimensional display mode to the two-dimensional display mode if a switch request for switching the video content data, which is the target of display, to other video content data occurs while the display control module is displaying the video content data, which is the target of display, in the first three-dimensional display mode.

2. The electronic apparatus of claim 1, wherein the display control module is configured to display, in a second three-dimensional display mode, a three-dimensional image which is obtained by converting the video content data, which is the target of display, to three-dimensional video data, and
the display mode changing module is configured to keep the display mode of the display control module to be the second three-dimensional display mode, if the switch request occurs while the display control module is displaying the video content data, which is the target of display, in the second three-dimensional display mode.

3. The electronic apparatus of claim 1, wherein the display mode changing module is configured to determine, if the switch request occurs while the display control module is displaying the video content data, which is the target of display, in the first three-dimensional display mode, whether the other video content data is three-dimensional video data of a three-dimensional format, based on an identifier of the other video content data, and to keep the display mode of the display control module to be the first three-dimensional display mode, if the other video content data is the three-dimensional video data of the three-dimensional format.

4. The electronic apparatus of claim 2, wherein the display mode changing module is configured to determine, if the switch request occurs while the display control module is displaying the video content data, which is the target of display, in the second three-dimensional display mode, whether the other video content data is three-dimensional video data of a three-dimensional format, based on an identifier of the other video content data, and to change the display mode of the display control module to the first three-dimensional display mode, if the other video content data is the three-dimensional video data of the three-dimensional format.

5. The electronic apparatus of claim 1, further comprising a tuner configured to receive a broadcast signal and to output broadcast program data of a channel, which is a target of viewing, in the broadcast signal,
wherein the video content data which is the target of display is the broadcast program data of the channel which is the target of viewing and is output from the tuner, and
the display mode changing module is configured to change the display mode of the display control module from the first three-dimensional display mode to the two-dimensional display mode, if a channel switch request for switching the channel which is the target of viewing to another channel occurs while the display control module is displaying the broadcast program data of the channel which is the target of viewing in the first three-dimensional display mode.

6. The electronic apparatus of claim 5, wherein the display control module is configured to display, in a second three-dimensional display mode, a three-dimensional image which is obtained by converting the broadcast program data of the channel, which is the target of viewing, to three-dimensional video data, and
the display mode changing module is configured to keep the display mode of the display control module to be the second three-dimensional display mode, if the channel switch request occurs while the display control module is displaying the broadcast program data of the channel which is the target of viewing in the second three-dimensional display mode.

7. The electronic apparatus of claim 5, wherein the display mode changing module is configured to determine, if the channel switch request occurs while the display control module is displaying the broadcast program data, which is the target of viewing, in the first three-dimensional display mode, whether broadcast program data of said another channel is three-dimensional video data of a three-dimensional format, based on an identifier which is added to the broadcast program data of said another channel, and to keep the display mode of the display control module to be the first three-dimensional display mode, if the broadcast program data of said another channel is the three-dimensional video data of the three-dimensional format.

8. The electronic apparatus of claim 5, wherein the display mode changing module is configured to determine, if the channel switch request occurs while the display control module is displaying the broadcast program data of the channel, which is the target of viewing, in the second three-dimensional display mode, whether broadcast program data of said another channel is three-dimensional video data of a three-dimensional format, based on an identifier which is added to the broadcast program data of said another channel, and to change the display mode of the display control module to the first three-dimensional display mode, if the broadcast program data of said another channel is the three-dimensional video data of the three-dimensional format.

9. A display control method of displaying video content data, comprising:
displaying each of frame images of video content data which is a target of display, if a display mode is a two-dimensional display mode;
displaying, if the display mode is a first three-dimensional display mode, a three-dimensional image by using, as a left-eye image and a right-eye image, images on two areas in each of the frame images of the video content data which is the target of display; and
changing the display mode from the first three-dimensional display mode to the two-dimensional display mode if a switch request for switching the video content data, which is the target of display, to other video content data occurs while the display mode is the first three-dimensional display mode.

10. A computer-readable, non-transitory computer readable medium having stored thereon a program configured to cause a computer to:
display each of frame images of video content data which is a target of display, if a display mode is a two-dimensional display mode;
display, if the display mode is a first three-dimensional display mode, a three-dimensional image by using, as a left-eye image and a right-eye image, images on two areas in each of the frame images of the video content data which is the target of display; and
change the display mode from the first three-dimensional display mode to the two-dimensional display mode if a switch request for switching the video content data, which is the target of display, to other video content data occurs while the display mode is the first three-dimensional display mode.
